(19) United States
(12) Patent Application Publication
(10) Pub. No.: US 2018/0288040 A1
(43) Pub. Date: Oct. 4, 2018

(54) System and Method for Biometric Authentication-Based Electronic Notary Public

(71) Applicant: JPMorgan Chase Bank, N.A., New York, NY (US)

(72) Inventors: Eren Kursun, New York, NY (US); Gene Fernandez, New York, NY (US); Alex Berson, New York, NY (US); Brian Goodman, New York, NY (US)

(73) Assignee: JPMorgan Chase Bank, N.A., New York, NY (US)

(21) Appl. No.: 14/075,895

(22) Filed: Nov. 8, 2013

Related U.S. Application Data
(60) Provisional application No. 61/882,230, filed on Sep. 25, 2013.

(51) Int. Cl. H04L 29/06

(52) U.S. Cl. CPC H04L 63/0861

(57) ABSTRACT

Systems and methods for biometric authentication-based electronic notary public are disclosed. A method for biometric authentication-based electronic notary public using an electronic device may include (1) a server comprising at least one computer processor receiving, from an electronic device, biometric data from a user; (2) the server authenticating the user based on the biometric data; (3) the server receiving, from the electronic device, an identification of a document to notarize; (4) the server receiving, from the electronic device, a signature of the user; (5) the server processing the document to include the signature and a notary seal; and (6) the server providing the processed document to the user.

### RELATED APPLICATIONS

The disclosures of the following are hereby incorporated, by reference, in their entireties: U.S. Pat. Nos, 8,028,896 and 7,117,365; U.S. patent applications Ser. Nos. 14/010,061; 13/908,618; 13/940,799; 61/844,097: 13/492,126; 13/297,475; 11/337563, 12/534,167; 10/867,103; 12/715,520; 10/710,315; 10/710,328; 11/294,785; and U.S. Provisional Patent Application Ser. Nos. 61/882,230; 61/861,690; 61/866,572; 61/861,690; 61/861,676; 61/820,917; 61/823,669.

### BACKGROUND OF THE INVENTION

### 1. Field of the Invention

The present invention generally relates to biometric authentication, and, more particularly, to a system and method for a biometric authentication-based notary public.

### 2. Description of the Related Art

The traditional notary public process may be inconvenient and time-consuming. Often, the individual is required to visit a notary public location or bank branch, and requires the user to present identification, sign a document in the presence of a notary, and, in some cases, provide verbal confirmation of the transaction.

### SUMMARY OF THE INVENTION

Systems and methods for biometric authentication-based notary public are disclosed. In one embodiment, a method for biometric authentication-based electronic notary public using an electronic device may include (1) a server comprising at least one computer processor receiving, from an electronic device, biometric data from a user; (2) the server authenticating the user based on the biometric data; (3) the server receiving, from the electronic device, an identification of a document to notarize; (4) the server receiving, from the electronic device, a signature of the user; (5) the server processing the document to include the signature and a notary seal; and (6) the server providing the processed document to the user.

In one embodiment, the step of authenticating the user may include the server confirming that the received biometric data matches the stored biometric data for the user.

In one embodiment, the step of receiving, from the electronic bile device, an identification of a document to notarize includes the server receiving an image of the document to notarize.

In one embodiment, the step of receiving, from the electronic device, an identification of a document to notarize includes the server retrieving, from a database, the identified document.

In one embodiment, the method may further include the server receiving, from the electronic device, at least one of an image or video of the user signing the document.

In one embodiment, the method may further include the server receiving, from the electronic device, at least one of audio and video of a statement made by the user.

In one embodiment, the processed document may include a watermark, and the watermark may include location data for stored data associated with the notary process.

In one embodiment, the processed document may be provided to the user by electronic delivery. In another embodiment, the processed document may be provided to a destination identified by the user.

In one embodiment, the electronic device may be a mobile electronic device. In another embodiment, the electronic device may be a kiosk.

In one embodiment, the method may further include the server receiving a location of the user; and the server verifying that the location of the user is acceptable.

Methods for using a biometric authentication-based electronic notary public kiosk are disclosed. According to one embodiment, the method may include (1) a kiosk comprising at least one computer processor receiving biometric data from a user; (2) the kiosk providing the biometric data to a server; (3) the kiosk receiving authentication from the server; (4) the kiosk receiving an identification of a document to notarize; (5) the kiosk providing the identification of the document to a server; (6) the kiosk receiving a signature of the user; (7) the kiosk providing the signature to the server; and (8) the kiosk receiving, from the server, a processed document comprising the signature and a notary seal.

In one embodiment, the method may further include the kiosk receiving authentication from a trusted mobile device.

In one embodiment, the method may further include the kiosk printing the processed document.

In one embodiment, the method may further include the kiosk capturing one of an image and a video of the user entering a signature.

In one embodiment, the step of the kiosk receiving an identification of a document to notarize may include the kiosk scanning the document to notarize.

Systems for notarizing a document using a mobile device are disclosed. According to one embodiment, the system may include a mobile device comprising at least one computer processor and an executable computer program that is tangibly embodied on a computer readable medium that causes the at least one computer processor to perform the following: (a) receive biometric data from a user; (b) provide the biometric data to a server; (c) receive authentication from the server; (d) receive at least one of an image and a video comprising a document with a signature of the user; (e) receive, from the server, an instruction to notarize the document; and (f) mark the document using a marking device.

In one embodiment, the marking device may be an accessory for the mobile device.

In one embodiment, the marking device may be a printer.

In one embodiment, techniques to perform notary functions by biometrically authenticating a user's identity, and acquiring biometrics and user data for the notary transaction are disclosed.

In one embodiment, techniques to acquire a user's biometrics to match the target security and transaction specs for the notary functionality desired are disclosed.

In one embodiment, techniques to acquire multi-modal biometrics (e.g., face, voice, behavioral biometrics, hand biometrics, signature biometrics, etc.) for authentication are disclosed.

In one embodiment, techniques to directly link the steps of the notary process and to associate the resulting records with the transaction for future reference and the corresponding documentation such as papers are disclosed.

In one embodiment, biometrics from a user's face (e.g., iris, etc.) may be used for biometric authentication.

In one embodiment, voice biometrics from the user that may specifically identify the notary functionality to be performed and the transaction specifics are disclosed.

In one embodiment, the use of a user's signature biometrics (on a touchpad, on video, etc.) through the signing of the forms for the notary process are disclosed.

In one embodiment, a user's hand biometric through signing the paperwork along with the images of the paperwork may be captured.

In another embodiment, additional data, such as location data (e.g., GPS), other forms of biometrics, user profile data, etc. may be used to meet the desired and/or required security levels of the transaction.

In one embodiment, techniques to combine the individual biometric markers in individual modalities through the acquisition to create composite markers for authentication (such as video of the user combining voice, face, behavioral biometrics, and signing the document simultaneously via multiple mobile device cameras on both sides of the device) are disclosed.

In one embodiment, data from the transaction may be collected and preserved for audits, future reference, etc.

In one embodiment, techniques to perform biometric authentication of the user using the acquired data for the specific transaction through cross checking the profile data and transaction data with the server end (of the financial institution) are disclosed.

In one embodiment, techniques to electronically stamp the documentation for notary through confirmation codes, electronic markers, email confirmation, mobile confirmation, etc., are disclosed.

In one embodiment the overlaying of authenticated signature on the scanned document, and providing the completed document to the user, is disclosed.

In one embodiment, techniques to physically stamp the documentation for notary through printed documents including the signature and paperwork are disclosed.

In one embodiment, techniques to physically stamp the documentation for notary using mobile device attachments that are activated after the user's identity and notary transaction are approved by the financial or notary institution are disclosed.

In one embodiment, techniques to combine mobile device-based biometric authentication and kiosk (or other stationary based authentication) for high levels of security are disclosed.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a block diagram of a system for biometric authentication-based electronic notary public using a mobile device according to one embodiment;

FIG. 2 is a block diagram of a system for biometric authentication-based electronic notary public using a kiosk according to one embodiment;

FIG. 3 is a flowchart depicting a method for biometric authentication-based electronic notary public using a mobile device according to one embodiment;

FIG. 4 is a flowchart depicting a method for biometric authentication-based electronic notary public using a kiosk according to one embodiment; and

FIG. 5 is a flowchart depicting a method for biometric authentication-based electronic notary public using a mobile device according to one embodiment.

### DETAILED DESCRIPTION OF PREFERRED EMBODIMENTS

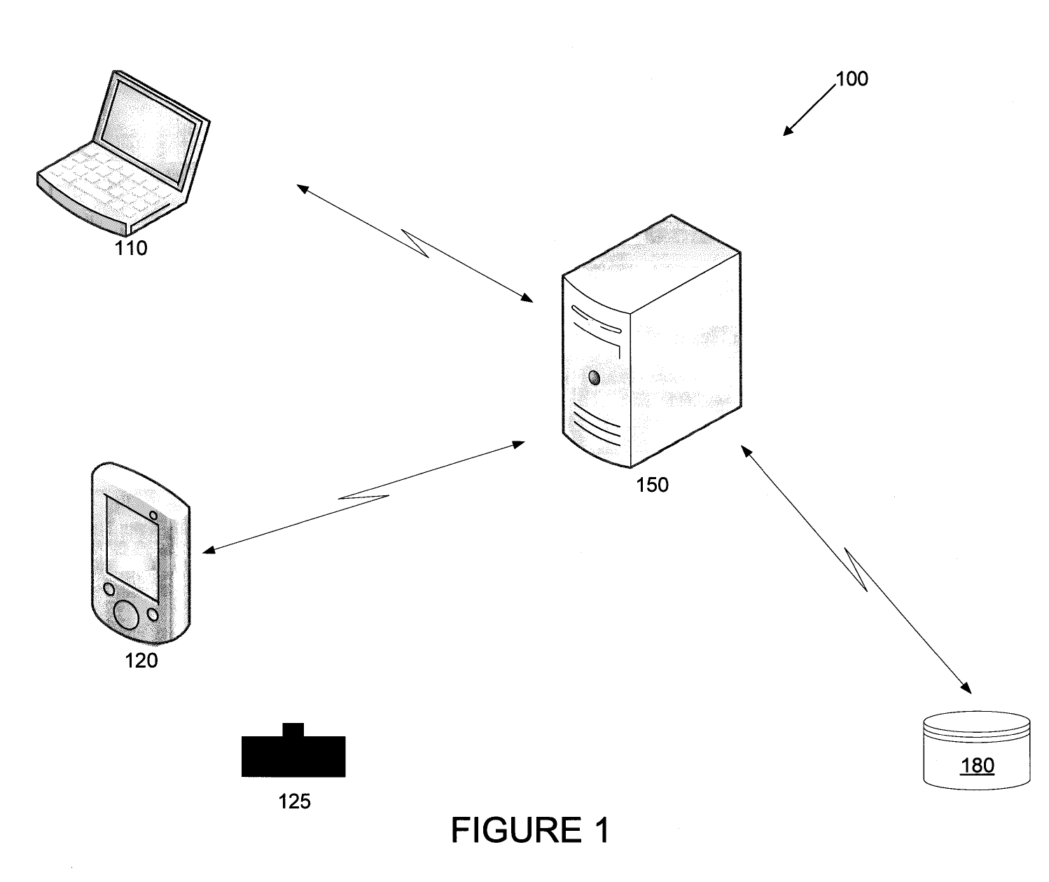

Several embodiments of the present invention and their advantages may be understood by referring to FIGS. 1-5, wherein like reference numerals refer to like elements.

Systems and methods for a biometric authentication-based electronic notary public are disclosed.

Referring to FIG. 1, a system for biometric authentication-based electronic notary public using a mobile device according to one embodiment is disclosed. System 100 may include mobile computer 110, “smart” phone 120, server 150, and database 180.

In one embodiment, mobile computer 110 may be any suitable computer, including laptop computers, notebook computers, tablet computers, e-reading devices, etc. Smart phone 120 may be any suitable device, including Apple iPhone, Research in Motion Blackberry, Samsung Galaxy, etc.

In one embodiment, mobile computer 110 and smart phone 120 may include at least one camera, microphone, scanner, and other input devices as is necessary and/or desired.

Mobile computer 110 and smart phone 120 may execute an application, program, or other software bundle for a biometric authentication-based notary public.

In one embodiment, mobile computer 110 and smart phone 120 may include stamping/printing device 125 that may be used to affix and/or print a notary seal, electronic signature, etc. on a notarized document. In one embodiment, stamping/printing device 125 may be an accessory for mobile computer 110 and smart phone 120 and may use any suitable interface (e.g., USB, Apple Lightning, wireless, etc.).

In one embodiment, stamping/printing device 125 may also print or stamp a watermark, machine-readable code (e.g., QR code, bar code, etc.) that may identify a storage location for documents, videos, etc. that may be associated with the notary process. For example, images, videos, etc. of the user the user's identification, the user executing the document, the user making a statement, user's biometrics, location data, the document, etc. may be stored and retrieved as necessary and/or desired.

Server 150 may be one or more servers that communicate with mobile computer 110 and/or smart phone 120 via a network, for example, the Internet, a cellular network, etc. Any suitable network may be used as is necessary and/or desired. Server 150 may also communicate with database 180 that may store data for the user. Server 150 may further communicate with other resources, such as government agencies, libraries, etc. to retrieve documents/forms to be notarized and/or send notarized documents.

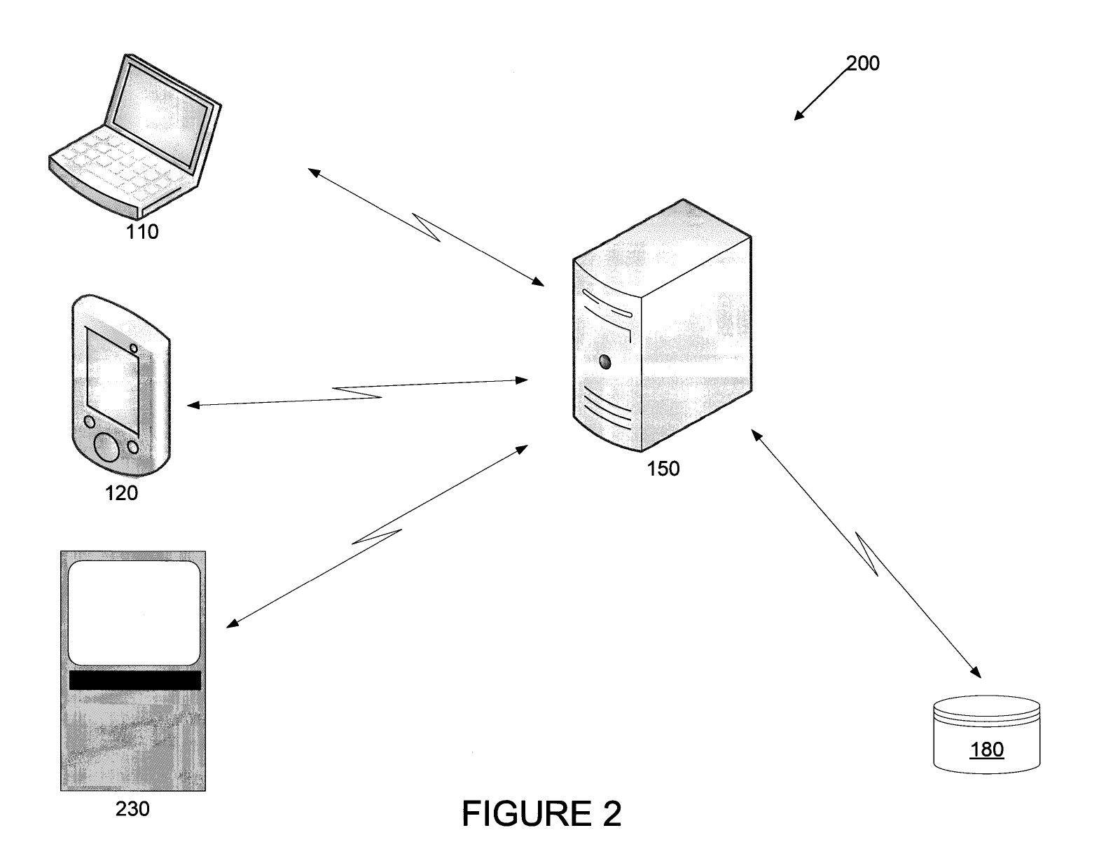

Referring to FIG. 2, a system for biometric authentication-based electronic notary public using a kiosk according to one embodiment is disclosed. System 100 may include mobile computer 110, “smart” phone 120, kiosk 230, server 150, and database 180.

In one embodiment, kiosk 230 may be a dedicated notary device. In another embodiment, kiosk 230 may be part of a kiosk having addition functionality (e.g., an ATM, an electronic teller, etc.).

In one embodiment, kiosk 230 may have baseline automatic teller machine ATM) functionality. Kiosk 230 may have biometric kiosk capability where high accuracy iris recognition, face recognition, signature recognition, gait recognition, finger print and vein readers, behavioral biometrics and other capabilities are incorporated through cameras, scanners, microphones, video recording devices, etc. Kiosk 230 may have connectivity to nearby mobile devices, such as a user's mobile phone, tablet computer, biometric identification devices/chips, etc. through any suitable communication mechanism (e.g., WiFi, Bluetooth, Near Field Communication, infrared, cellular, etc.)

In one embodiment, kiosk 230 may include at least one camera, a document scanner, a screen that may be a touch-sensitive screen, a signature pad, a printer, and any input/output devices as necessary and/or desired.

In system 100 or 200, a representative (not shown) may be provided with data from server 150 and may determine whether or not to notarize the documents. For example, a human may be presented with user authentication data (e.g., biometric data), analysis of that data, etc. and may determine whether or not he or she is satisfied that the user is who he or she purports to be. If the representative is satisfied, the representative may approve notarization.

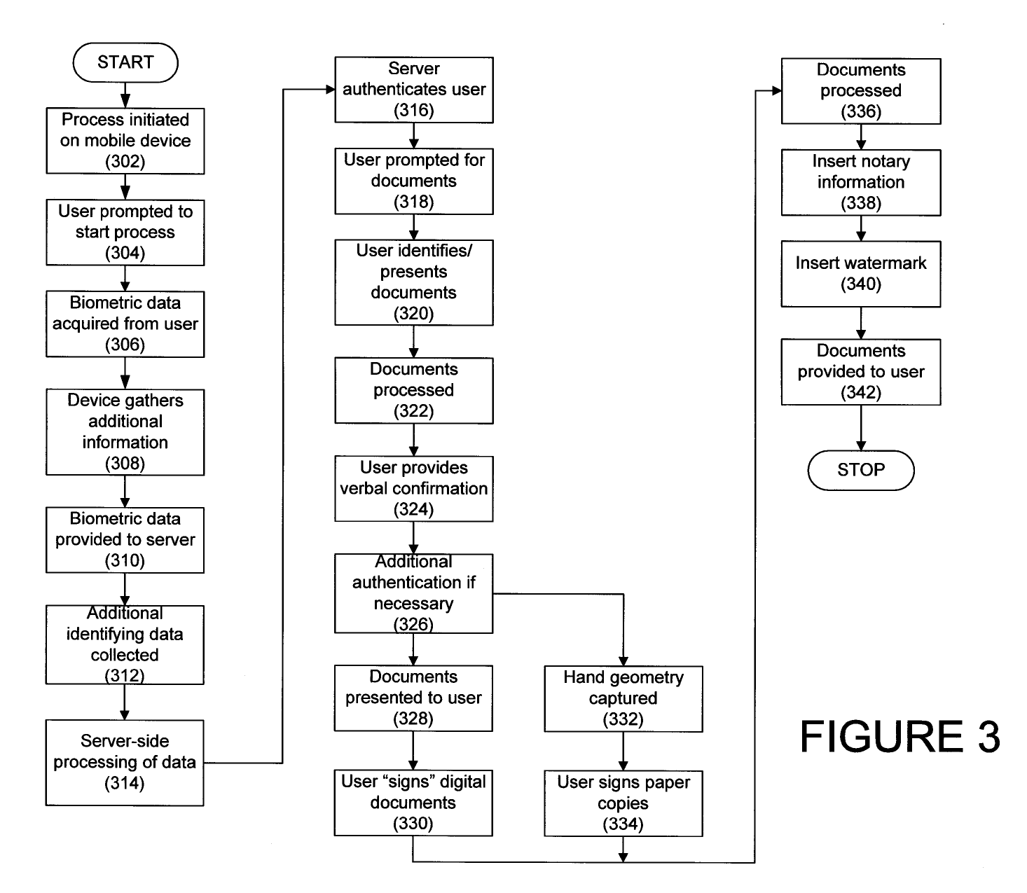

Referring to FIG. 3, a method for biometric authentication-based electronic notary public using a mobile device according to one embodiment is disclosed, in step 302, the process may be initiated on a mobile device. Any suitable mobile device may be used, including, for example, laptop computers, tablet computers, PDAs, smart phones, e-readers, biological computers, organic computers, smart, chip devices, smart paper devices, etc. Any other suitable electronic device may be used as necessary and/or desired.

In one embodiment, an application, software program, etc. may be executed on the mobile device.

In one embodiment, the user may need to register him or herself before being able to use the application. In one embodiment, the registration may be performed using biometric data. Examples of such registration are disclosed in U.S. patent application Ser. No. 13/908,618 and U.S. patent application. Ser. No. 13/972,556, the disclosures of which are incorporated, by reference, in their entireties.

In another embodiment, the user may register using a trusted device. The registration may be performed using the mobile device such as acquiring biometrics data from the user. This biometrics data could be face, voice, iris, finger print, signature, hand, vein, palm print, behavioral biometrics etc. The user may be asked to enter other passwords or one-time verification codes to fully authenticate.

In another embodiment, the registration may be performed using a kiosk (ATM, biometric kiosk, etc.) for detailed profiling. This may be used for high security notary applications. In another embodiment the registration step can involve stationary kiosk and mobile stages, where part of the data is acquired through kiosk, others through mobile devices and the data is then cross checked for consistency and accuracy. Any suitable registration process may be used as necessary and/or desired.

In step 304, the user may be prompted to start the notary process. In one embodiment, the user may be asked to specify the type of transaction for the notary. For example, the user may select, from drop-down boxes, a list of forms, or may enter the type of transaction, such as power of attorney, affidavit, certificate, etc. In one embodiment, each type of transaction may have different security specifications and biometrics modalities associated therewith.

In step 306, the application may then gather biometric data from the user. The amount of biometric data that is collected may depend, for example, on the level of security associated with the transaction. In one embodiment, the biometric data may include, for example, face biometrics e.g., scanning/imaging a user's face, irises, etc.), voice biometrics, hand biometrics, signature biometrics, behavioral biometrics, etc.

In step 308, the application may gather additional data. For example, the device may gather user location data, such as GPS data. Thus, if the transaction is being conducted outside of the user's registered locations (e.g., home, work, travel), additional authentication may be required.

In another embodiment, the location data may be used to access a library of location-specific forms/documents for the user. For example, the user's location may be used to retrieve state specific powers of attorney, forms, etc.

In step 310, the user's biometric data may be provided to the server for processing and authentication. In one embodiment, this may involve processing individual biometrics, processing integrated biometrics, etc. In one embodiment, the user's biometric data may be acquired and processed during any point of the transaction. In addition, the user's biometric data may be acquired continuously during the transaction and processed accordingly. Any suitable method for capturing and/or processing biometric data may be used as necessary and/or desired.

In step 312, any additional information may be collected. For example, the user may be required to enter a userid, present identifying documents (e.g., driver's license, passport, etc.). This additional information may be processed by the mobile device and/or provided to the server as

In step 314, the server may process the data received from the mobile device. This may include, for example, checking the user's registered mobile device information with the registered device information, checking a user's GPS location, checking other basic user information, checking the identification form presented, etc.

In step 316, the server may authenticate the user. In one embodiment, the server and/or mobile device may authenticate the user based on the collected data during the session by calculating a matching score between the collected data and stored data of the user, such as the user's profile. In one embodiment, the matching may be based on multiple biometric modalities including, for example, face, voice, signature, iris, gait, palm print, fingerprint, hand, vein, behavioral biometrics, etc. A combined matching score may be calculated for more than one of these modalities. In addition, other data such, as a user's basic information, registered device, identification presented, GPS location, other profile data, etc. can be considered.

In step 318, the user may be prompted for documents to be notarized and, in step 320, the user may identify the documents, in one embodiment, the user may scan the documents. In another embodiment, the user may image the documents using the mobile device's camera. In another embodiment, the user may submit the documents by facsimile. In another embodiment, the user may identify the documents from a website, such as a government website. In still another embodiment, the user may select the documents from a document library. Any suitable way or source of documents may be used as is necessary and/or desired.

In step 322, the documents may be processed by the server. In one embodiment, this may include checking whether the documents presented or selected meet the requirements of the transaction. If the documents do not meet the requirements, a warning may be generated, the process may be terminated, etc.

In one embodiment, each biometric modality or the integrated biometric markers may be checked against the user's profile. In one embodiment, the profile may be generated when the user registers. The profile may be used to authenticate the user.

In step 324, the user may verbally recite any statements that he or she may need to recite in front of a traditional notary public. For example, the user may state “I, John Smith, on the first of January in 2010, presented document XYZ to notary public Q.”

In one embodiment, the user may be asked to verbally recite a statement while holding identification. For example, the user may be required to record a video of the speaking his or her name and holding a drivers' license.

In one embodiment, biometric data may be extracted from the audio/video and may be analyzed to verify that the speaker is the user. In another embodiment, the user may be asked to verify that the documents are authentic. In another embodiment, the user may be asked to describe the documents, read a portion (or all) of the documents, etc. In one embodiment, the questions might be randomized or may be standardized depending on the security level required by the transaction.

In step 326, the server and/or application may determine if additional data is necessary. For example, for certain documents, in step 332, a user may be required to place his or her hands on the document and have the combination imaged by, for example, the camera on the mobile device, and, in step 334, may then sign the document.

In step 328, the documents may be presented to the user. In one embodiment, the documents may be presented on the screen of the mobile device and, in step 330, the user may sign the digital documents. In one embodiment, the user may sign the documents using a stylus, the user's finger, etc.

In step 336, the documents may be processed. In one embodiment, the electronically-acquired signature may be overlaid on the electronic copy of the documents. If the user scanned the document using a scanner, a facsimile machine, etc., then the document may be overlaid on the server site. In still another embodiment, if the user provided the document by email, web form, etc., then the signature may be embedded on the electronic document.

In step 338, the system may enter a notary public seal on the document. The seal may be in an electronic form. For example, it may include a serial number and a reference to an electronic notary. It another embodiment, it may be a reference number. In another embodiment, the number may be presented to the user in an email, and the user may write the number on the paper copy. In another embodiment, it may be an attachment that is provided to the electronic document so that an electronically controlled stamp might be activated when the authentication is completed so the user can physically stamp the document. In another embodiment, the server may provide, by electronic mail, facsimile, etc. the integrated document. Any suitable stamp may be provided as necessary and/or desired.

In step 340, a watermark may be inserted into the documents. In one embodiment, a digital watermark may be provided so that when the document is scanned, some or all of the information associated with the notary process may be retrieved.

In one embodiment, a machine-readable code, such as QR code, may be provided on the documents that may link to the data acquired in the notary public process. For example, images, videos, etc. of the user, the user's identification, the user executing the document, the user making a statement, user's biometrics, location data, the document, etc. may be stored and retrieved as necessary and/or desired.

In step 142, the documents may be provided to the user. The documents may be sent by electronic mail, facsimile, text message, through a pointer to a network location, etc. In one embodiment, the documents may be provided to the appropriate destination. For example, if the document is a power of attorney to be submitted to the state department of motor vehicles, the system may directly send the documents to the department of motor vehicles.

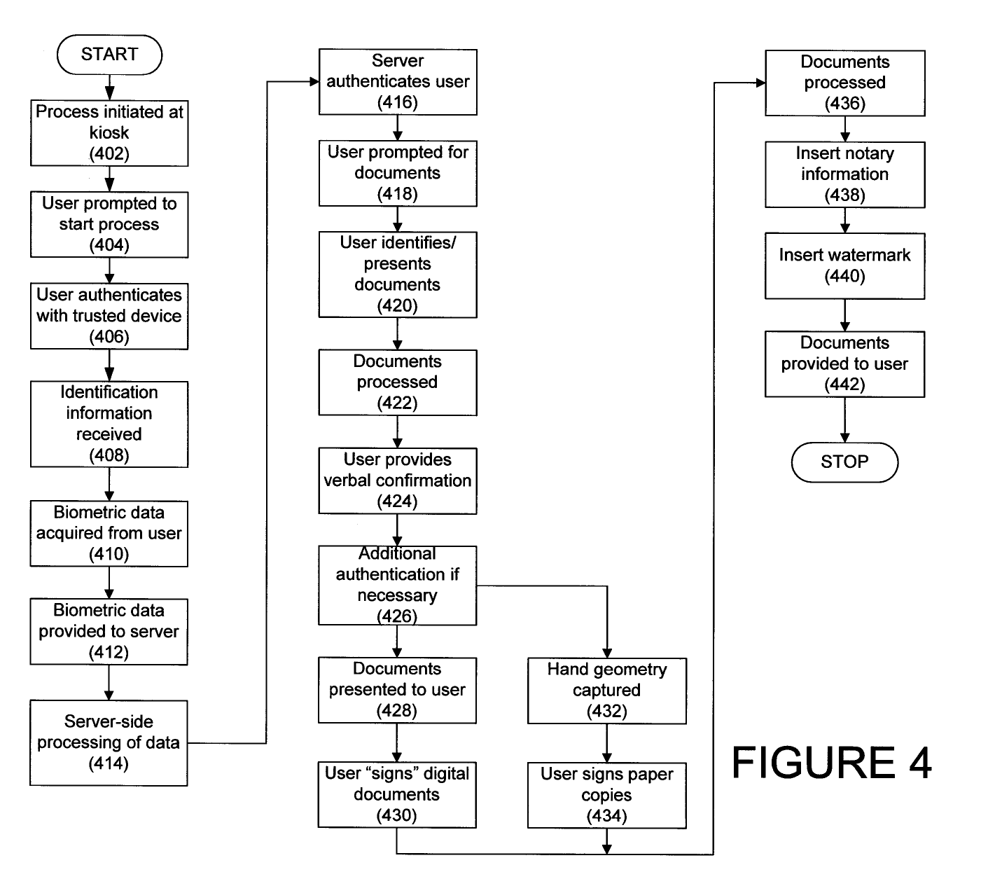

Referring to FIG. 4, a method for biometric authentication-based electronic notary public using a kiosk according to one embodiment is disclosed. In step 402, the process may be initiated on a kiosk, ATM, video teller, terminal, or other device.

In step 404, the user may be prompted for authentication. In one embodiment, the user may be prompted for biometric authentication.

In step 406, the user may present identification to the kiosk. In another embodiment, the user may be authenticated using a trusted mobile device that may communicate with the kiosk using any suitable communication mechanism, such as Near Field Communication, Bluetooth, WiFi, etc.

In step 408, the user may present any additional identifying documents to the kiosk. In one embodiment, the documents may be imaged, scanned, etc., by the kiosk.

In step 410, the user's biometric data may be acquired through the kiosk. In one embodiment, this may be similar to step 306, above. In one embodiment, in addition to face biometrics, voice biometrics, and signature, the kiosk may capture height, weight, hand geometry, hand/vein, behavior, gait, etc.

In one embodiment, the user may be required to enter a PIN or other access code.

In one embodiment, the kiosk may ask the user to perform clicks, motions, gestures, etc., to capture addition biometric data.

In step 412, the data may be provided to the server. This may be similar to step 312, above.

In step 414, the server may perform processing of the received data. This may be similar to step 314, above.

In step 416, the server may authenticate the user's identity. This may be similar to step 316, above.

In step 418, the user may be prompted for the documents to be notarized. This may be similar to step 318, above.

In step 420, the user may present or select the documents to be notarized. This may be similar to step 320, above.

In step 422, the server may process the documents. This may be similar to step 322, above.

In step 424, the user may verbally recite any statements that he or she may need to recite in front of a traditional notary public. This may be similar to step 324, above.

In step 426, the server and/or kiosk may determine if additional data is necessary. This may be similar to step 326, above.

In step 432 and 434, if additional data is necessary, the user's hand geometry and signature data may be collected. These steps may be similar to steps 332 and 334, above.

In step 428, the user may be presented with electronic documents with signature boxes on the screen of the kiosk. This may be similar to step 328, above.

In step 430, the user may sign or verify the documents on the kiosk. In one embodiment, the user may “sign” the documents using the kiosk's touch sensitive screen, a signature pad, etc.

In step 436, the documents may be processed. This may be similar to step 336, above.

In step 438, the system may insert notary public information. This may be similar to step 338, above.

In step 440, a watermark or other reference may be included in the documents. This may be similar to step 340, above.

In step 442, the documents may be provided to the user. This may be similar to step 342, above.

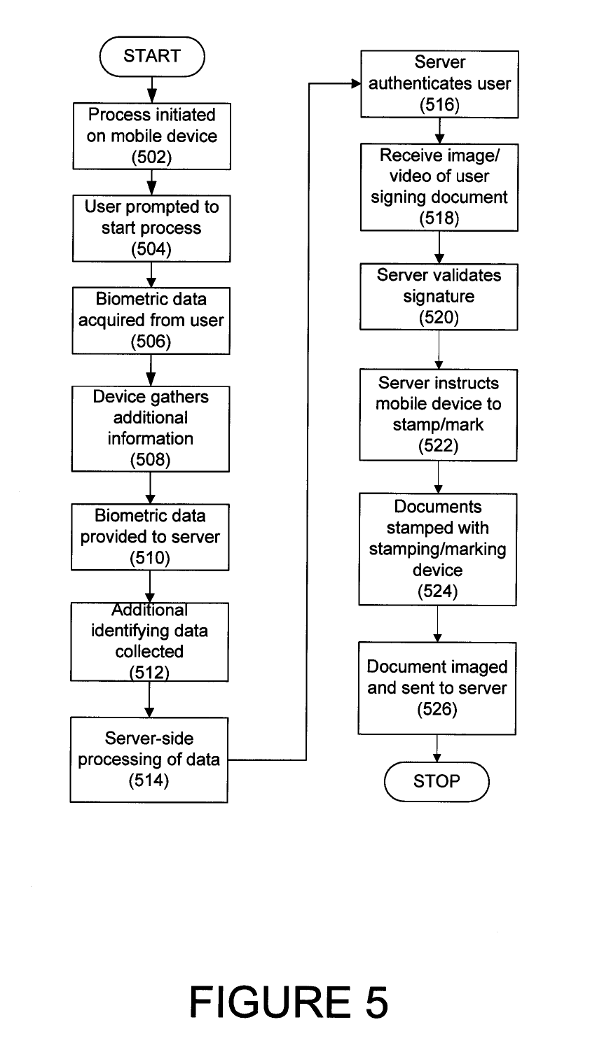

Referring to FIG. 5, a method for biometric authentication-based electronic notary public using a mobile device according to one embodiment is disclosed. In step 502, the process may be initiated on a mobile device, such as a smart phone, tablet computer, etc.

In step 504, the user may be prompted for authentication. In one embodiment, the user may be prompted for biometric authentication.

In step 506, the application may then gather biometric data from the user. The amount of biometric data that is collected may depend, for example, on the level of security associated with the transaction. In one embodiment, the biometric data may include, for example, face biometrics (e.g., scanning/imaging a user's face, irises, etc.), voice biometrics, hand biometrics, signature biometrics, behavioral biometrics, etc.

In step 508, the application may gather additional data. For example, the device may gather user location data, such as GPS data. Thus, the transaction is being conducted outside of the user's registered locations (e.g., home, work, travel), additional authentication may be required.

In another embodiment, the location data may be used to access a library of location-specific forms/documents for the user. For example, the user's location may be used to retrieve state specific power of attorneys, forms, etc.

In step 510, the user's biometric data may be provided to the server for processing and authentication. In one embodiment, this may involve processing individual biometrics, processing integrated biometrics, etc. In one embodiment, the user's biometric data may be acquired and processed during any point of the transaction. In addition, the user's biometric data may be acquired continuously during the transaction and processed accordingly. Any suitable method for capturing and/or processing biometric data may be used as necessary and/or desired.

In step 512, any additional information may be collected. For example, the user may be required to enter a userid, present identifying documents (e.g., driver's license, passport, etc.). This additional information may be processed by the mobile device and/or provided to the server as is necessary and or desired.

In step 514, the server may process the data received from the mobile device. This may include, for example, checking the user's registered mobile device information with the registered device information, checking a user's GPS location, checking other basic user information, checking the identification form presented, etc.

In step 516, the server may authenticate the user. In one embodiment, the server and/or mobile device may authenticate the user based on the collected data during the session by calculating a matching score between the collected data and stored data of the user, such as the user's profile. In one embodiment, the matching may be based on multiple biometric modalities including, for example, face, voice, signature, iris, gait, palm print, fingerprint, hand, vein, behavioral biometrics, etc. A combined matching score may be calculated for more than one of these modalities. In addition, other data such, as a user's basic information, registered device, identification presented, GPS location other profile data, etc. can be considered.

In step 518, the mobile device may capture an image or video of the user executing the documents to be notarized. In one embodiment, the document may be identified.

In step 520, the server may validate the received signature and/or additional biometric data that may be captured during the signing.

In step 522, the server may instruct the mobile device to stamp and/or mark the document that the user signed.

In step 524, the mobile device may cause a stamping device to stamp or mark the document. In one embodiment, the stamping device may be a printer, a thermal printing device, a label maker, etc. Any suitable device that may indicate the notary effect on the signed document may be used as necessary and/or desired.

In one embodiment, a watermark, machine-readable code (e.g., QR code), etc., may be further stamped printed on the document.

In one embodiment, in step 526 the stamped document may be imaged by the mobile device and provided to the server for storage.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ 8 operating system, Microsoft Windows™7 operating system, the Microsoft Windows™ Vista™ operating system, the Microsoft Windows™ XP ™ operating system, the Microsoft Windows™ NT™ operating system, the Windows™ 2000 operating system, the Unix operating system, the Linux operating system, the Xenix operating system, the IBM AIX™ operating system, the Hewlett-Packard LIX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, intranet, Extranet, LAN, an Ethernet, wireless communication via cell tower or, satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, with departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. An automated method for biometric authentication-based electronic notarization, comprising:
a server comprising at least one computer processor receiving, from a mobile electronic device, biometric data for a user;
the server receiving mobile device identification information from the mobile electronic device;
the server verifying that the mobile device identification information that is received matches a stored mobile device identification that is associated with the user;
the server receiving, from a GPS sensor on the mobile electronic device, GPS location data for the mobile electronic device;
the server retrieving a plurality of registered user locations for the user;
the server verifying that the GPS location data matches one of the registered user locations;
without interaction from a human notary, the server authenticating the user based on the biometric data;
the server receiving, from the mobile electronic device, an identification of a document to notarize;
the server receiving, from the mobile electronic device, a written signature of the user;
without interaction from the human notary, the server processing the document to include the written signature and a notary seal; and
the server providing the processed document to the user.

2. The method of claim 1, wherein authenticating the user comprises:
the server confirming that the received biometric data matches stored biometric data for the user.

3. The method of claim 1, wherein receiving, from the mobile electronic device, the identification of the document to notarize comprises:
the server receiving an image of the document to notarize.

4. The method of claim 1, wherein receiving, from the electronic device, the identification of the document to notarize comprises:
the server retrieving, from a database, the document identified to be notarized.

5. The method of claim 1, further comprising:
the server receiving, from the mobile electronic device, at least one of an image or video of the user signing the document.

6. The method of claim 1, further comprising:
the server receiving, from the mobile electronic device, at least one of audio and video of a statement made by the user.

7. The method of claim 1, wherein the processed document further comprises a watermark.

8. The method of claim 7, wherein the watermark comprises location data for stored data associated with the server.

9. The method of claim 1, wherein the processed document is provided to the user by electronic delivery.

10. The method of claim 1, wherein the processed document is provided to a destination identified by the user.

11-18. (canceled)

19. A system for notarizing a document using a mobile device, comprising:
a mobile electronic device associated with a user comprising:
at least one computer processor;
at least one input device that receives biometric data from a user; and
a GPS location sensor that provides GPS location data; and
a server in communication with the mobile electronic device, comprising:
at least one computer processor;
a memory; and
an executable computer program that is tangibly embodied on a computer readable medium that causes the at least one computer processor to perform the following:
receive the biometric data for the user from the mobile electronic device;
receive mobile device identification information from the mobile electronic device;
verifying that the mobile device identification information that is received matches a stored mobile device identification that is associated with the user;
receive the GPS location data from the mobile device;
retrieve a plurality of registered user locations for the user;
verify that the GPS location data matches one of the registered user locations;
authenticate the user based on the biometric data, resulting in an authentication;
communicate the authentication to the mobile electronic device;
receive an image of the document with a written signature of the user or a video comprising the document with the written signature of the user;
associating the image or the video with the biometric data, the GPS location data, and the authentication; and
communicate an instruction to notarize the document to the mobile electronic device.

20. The system of claim 19, wherein the mobile electronic device further comprises a marking device, and the marking device marks the document with a notary seal.

21. The system of claim 20, wherein the marking device is a printer.

22-23. (canceled)

24. The method of claim 1, wherein the biometric data is periodically received, and the user is periodically authenticated, until the processed document is provided to the user.

25. The method of claim 1, wherein the biometric data is continuously received, and the user is continuously authenticated, until the processed document is provided to the user.

26. The system of claim 19, wherein the biometric data is periodically received, and the user is periodically authenticated, until the processed document is provided to the user.

27. The system of claim 19, wherein the biometric data is continuously received, and the user is continuously authenticated, until the processed document is provided to the user.
